(19) United States
(12) Patent Application Publication
(10) Pub. No.: US 2025/0216313 A1
(43) Pub. Date: Jul. 3, 2025

(54) Method and device for detecting and/or classifying particles of organic based compounds from a backscattered light fingerprint

(71) Applicants: INESC TEC - Instituto de Engenharia de Sistemas e Computadores, Tecnologia e Ciência, Porto (PT); Universidade do Porto, Porto (PT)

(72) Inventors: João Paulo TRIGUEIROS DA SILVA CUNHA, Porto (PT); Beatriz Isabel JACINTO BARROS, Porto (PT)

(21) Appl. No.: 18/841,727

(22) PCT Filed: Feb. 28, 2023
(86) PCT No.: PCT/EP2023/055044

§ 371 Date: Aug. 27, 2024

(30) Foreign Application Priority Data
Feb. 28, 2022 (PT) 117826

(51) Int. Cl. G01N 15/1429; G01N 15/1434

(52) U.S. Cl. CPC G01N 15/1429; G01N 15/1434

(57) ABSTRACT

A method and device for detecting and/or classifying particles of organic based compounds, i.e. bioparticles, from a backscattered light fingerprint, in a liquid dispersion sample, said method using an electronic data processor for detecting and/or classifying particles in the sample, the method uses the electronic data processor for pre-training a machine learning classifier with a plurality of specimen particles, and includes the steps of: emitting a laser modulated by a modulation frequency onto each specimen; acquiring a temporal signal from laser light backscattered by each specimen for a plurality of temporal periods of a predetermined duration for each specimen; calculating specimen phase-domain coefficients from the acquired specimen signal for each of the temporal periods by applying a phase-domain transform; and using the calculated specimen coefficients to pre-train the machine learning classifier for detecting and/or classifying the particles.

### TECHNICAL FIELD

The present disclosure relates to a method and device for detecting and/or classifying particles of organic based compounds, i.e. bioparticles, from a backscattered light fingerprint. In particular, the present disclosure relates to the detection of micron- or nano-sized particles of organic based compounds, i.e. bioparticles, through phase analysis of a back-scattering signal, further in particular using optical tweezers.

### BACKGROUND

The interactions of light with a biological material are a great source of information that can provide valuable insights in life sciences research [1]. By analyzing the different manifestations of such interactions through changes in the control variables of the light field such as amplitude, frequency, polarization, phase among others, several properties of the samples can be investigated [2]. For instance, the amount of light scattered by a particle is proven to be highly correlated with characteristics such as particle size, subcellular organization, refractive index, and content type (synthetic, biologic), thus being a widely used parameter to the identification and characterization of biological structures [3, 4]. Considering this, optical-based detection techniques are highlighted as very efficient methods to respond to the high demand by healthcare and pharmaceutical systems for selective, sensitive and reliable analytical devices, capable of detecting and discriminating different classes of particles [5], [6]. In particular, optical fiber-based biosensing systems are highly suitable candidates to meet the challenges associated with in-vivo analysis of single-molecules [7], [8]. The combination of advanced data analytics methods with the sensing ability of optical fibers can contribute to the development of “intelligent” micro-sensors able to differentiate particles. This was demonstrated and conceptualized through an approach named iLoF—intelligent Lab on Fiber [9]. By using a recent type of “opto-tools”—the Optical Fiber Tweezers (OFTs)—this fiber-based technique is capable of simultaneously trap microparticles and analyze the arising back-scattering signals, using Artificial Intelligence techniques based on parameters extracted from the sensor output signal, that provided a great performance (above 90% accuracy) in discriminating a wide range of microparticles including synthetic microspheres and complex cancer cells, only differing in surface glycosylation profiles [10]. It proved to be a very efficient, robust technique to analyze and differentiate small particles with high potential to “discover novel “biological signatures” of each main disease” [11].

These facts are disclosed in order to illustrate the technical problem addressed by the present disclosure.

### GENERAL DESCRIPTION

The present disclosure relates to a method and device for detecting and/or classifying particles of organic based compounds, i.e. bioparticles from a backscattered light fingerprint. In particular, this disclosure relates to a method and device for the detection of micron- or nano-sized particles of organic based compounds, i.e. bioparticles, through phase analysis of back-scattering signal, in particular obtained using optical tweezers, for example using miniaturized and integrated optical tweezers like optical fiber tweezers. Organic based compounds include synthetic organic compounds (e.g. organic synthetic polymers, polystyrene, poly(methyl methacrylate, etc)), organic compounds found in biological particles (e.g. cells) or natural organic compounds (e.g. organic natural polymers, biopolymers, etc).

In the iLOF technique [9], similarly to the majority of signal processing systems, information is captured from a set of temporal-related and magnitude spectral features. In contrast, the phase spectrum of the signals is discarded [12]-[15]. This is a common approach mainly due to the computational challenges associated with its calculation [16], [17]. Despite that, a plethora of evidence exists in unrelated fields to support the high informative content of phase [14], [18], [19]. Phase-based features have been successfully applied mostly in audio processing applications such as automatic speech recognition [20]-[22], speech enhancement [18], [25] and voice pathology detection [24], [25]. It has been demonstrated in unrelated fields that phase related information significantly assists the classification process, improving the recognition accuracy. [14], [26].

In the present disclosure good discriminative properties were found by analyzing the phase representation of biophotonic signals. Since the back-scattering signals acquired result from the reflection of light by the trapped particles, scattering patterns are present due to the interaction of light with the inherent properties of each structure. Hypothesising that phase retains information on the location of events, important patterns of laser light can be captured according to the present disclosure. Hereupon, we exploit in the present disclosure the following: (1) Can phase information of back-scattering signals be correlated with the structural properties and heterogeneity degree that characterize different synthetic and biological microparticles? (2) If so, do phase-derived features have discriminative potential to detect and differentiate microparticles, suspended in bio-fluids, based on OFT laser back-scattering signals? Is the discriminative potential enhanced with an increase in structural complexity of the particles and conditions evaluated? (3) Can phase-based features perform better than the commonly derived magnitude parameters in differentiation problems? In order to answers such questions, back-scattering signals of synthetic (Polystyrene, PMMA) and simple biological (Living yeast cell) microparticles and two types of cells derived from MKN45 gastric cell line, collected during iLOF development and validation, were analyzed. Although the phase component of a signal can be represented and analyzed using a variety of methods, in the majority of research conducted the phase information is estimated from the Fourier transform, following the first comprehensive studies on the use of phase spectrum in signal processing [19], [27], [28]. Therefore, in this analysis, the phase spectrum was explored through the Fourier domain representation, by conducting an exploratory statistical analysis to 8 phase-spectrum derived parameters and phase portion of the first, e.g. 40, coefficients of Fourier Transform. The phase spectrum of back-scattering signals showed to retain patterns related to the intrinsic properties of each particle, which were enhanced with higher heterogeneity degree and structural complexity. The set of attributes proved to be sensitive and robust to detect and discriminate microparticles. These findings introduce phase as a potential new domain to obtain discriminative light pattern features, strongly related to the structural properties of each cell, that can significantly enhance the automatic particle classification task to be deployed on the vision of multifunctional “all-in-fiber” probes, for point-of-care diagnostic and in-vivo biosensing.

Optical Fiber Tweezers (OFT) can be used to study manifestations of light-matter interactions and deduce properties of micron-or nano-sized bioparticles trapped within its laser focal point. An approach for this purpose based on optical signal processing obtained from an OFT system named iLoF—intelligent Lab on Fiber [9]—has provided very relevant results. In this disclosure we present a method and device designed to understand back-scattering signal, in particular OFT-based, phase parameters discriminative performance when compared with frequency spectrum magnitude previously used by the iLOF technology. Statistical analysis to 8 phase spectrum-derived features and phase portion of the corresponding first, e.g. 40, Fourier Transform coefficients obtained from back-scattering signals was performed and compared with the previous magnitude based parameters. The phase spectrum of back-scattering signals showed to retain patterns related to the intrinsic properties of each particle. The set of features proved to be robust to detect and discriminate from synthetic microparticles to highly similar cancer-derived mammalian cells, with better discriminative potential than their previous spectral magnitude counterparts. Phase is thus a potential new domain to obtain discriminative light pattern features from backscattering, in particular OFT-based, systems applied to micron- or nano-sized particles detection. The incorporation of phase-based features can extend the horizons for biophotonic signal processing systems. The high sensitivity of the analyzed phase features to different bioparticles, namely cancer-associated glycoforms, presents great potential for applications in point-of-care diagnosis, such as detection and identification of molecules with important clinical outcomes, circulating in the blood or its derivatives.

It is disclosed a device and method for detecting and/or classifying particles of organic based compounds, i.e. bioparticles, from a backscattered light fingerprint, in a liquid dispersion sample, said method using an electronic data processor for detecting and/or classifying particles of organic based compounds in the sample,
the method comprising the use of the electronic data processor for pre-training a machine learning classifier with a plurality of specimen particles of organic based compounds, comprising the steps of:
   emitting a laser modulated by a modulation frequency onto each specimen;
   acquiring a temporal signal from laser light backscattered by each specimen for a plurality of temporal periods of a predetermined duration for each specimen;
   calculating specimen phase-domain coefficients from the acquired specimen signal for each of the temporal periods by applying a phase-domain transform;
   using the calculated specimen coefficients to pre-train the machine learning classifier for detecting and/or classifying the particles.

Organic based compounds include synthetic organic compounds (e.g. organic synthetic polymers, polystyrene, poly(methyl methacrylate, etc)), organic compounds found in biological particles (e.g. cells) or natural organic compounds (e.g. organic natural polymers, biopolymers, etc).

An embodiment comprises the use of the electronic data processor for detecting and/or classifying the particles of organic based compounds, i.e., comprising the steps of:
using a laser emitter to emit a laser modulated by a modulation frequency onto the sample;
using a light receiver to acquire a signal from laser light backscattered by the sample for a plurality of temporal periods of a predetermined duration;
calculating sample phase-domain coefficients from the acquired sample signal for each of the temporal periods by applying the same phase-domain transform as used for the specimen;
using the pre-trained machine learning classifier to detect and/or classify from the calculated sample coefficients the particles.

In an embodiment, the phase-domain transform used for obtaining phase-domain coefficients is the Fourier transform, the Hilbert transform or the Hartley transform.

In an embodiment, the phase-domain transform used for obtaining phase-domain coefficients is the Fourier transform calculated using the Discrete Fourier Transform, DFT, in particular implemented by a Fast-Fourier Transform, FFT.

In an embodiment, the phase-domain coefficients comprise the first coefficient, in particular the first 1-2, 1-3, 1-4, 1-5, 1-6, 1-7, 1-8, 1-9, 1-10, 1-12, 1-15, 1-18, 1-20, 1-25, 1-30,1-35, or 1-40 coefficients of the phase-domain transform.

In an embodiment, the phase-domain coefficients comprise the Standard Deviation, Root Mean square, Interquartile, Range, Kurtosis, Skewness, Variance, Entropy, or combinations thereof, extracted from a phase spectrum obtained from the applied phase-domain transform, in particular the phase-domain coefficients comprise the Standard Deviation, Root Mean square, Interquartile, Range, Kurtosis, Variance, Entropy, or combinations thereof.

In an embodiment, the calculating of phase-domain coefficients from the acquired signal comprises phase unwrapping the applied phase-domain transform.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

The following figures provide preferred embodiments for illustrating the disclosure and should not be seen as limiting the scope of invention.

FIG. 1: Representation of the signal processing and analysis pipeline applied to the acquired back-scattering signals. Adapted from [29].

FIG. 2: Bright-field microscopic images acquired for the different particles trapped: (A) PMMA, (B) Polystyrene and (C) Living yeast cell in distilled water (From [29]); (D) Mock cell, (E) HST6 cell, (F) PS particle in Phosphate Buffered Saline (PBS) (From [10]). Particles are trapped while the back-scattering signal is acquired through the same micro-lens on the top of the fiber. Examples of filtered portions of back-scattering signals obtained for each 4 classes of particles under analysis after processing steps, for Experiment 1 and Experiment 2.

FIG. 3: Unwrapped phase spectrum obtained after signal processing and phase unwrapping procedures. Experiment 1: (A) No particle trapped (Class 1), (B) PMMA particle (Class 2), (C) PS particle (Class 3) and (D) Living yeast cell (Class 4); Experiment 2: (E) No particle trapped (Class 1), (F) Mock cell (Class 2), (G) HST6 cell (Class 3) and (H) PS particle (Class 4).

FIG. 4: Graphical representation of the results obtained regarding the statistical comparisons involving 4 classes (Kruskall-Wallis test) and 2-classes (Mann-Whitney test), performed in experiment 1. (A) Results obtained for the first set of parameters: phase-spectrum derived statistical features. (B) Results obtained for the second set of parameters: Phase portion of the first 40 FFT coefficients. p-values obtained for each individual coefficient in 4-class comparison (top) and binary combinations (below).

FIG. 5: Graphical representation of p-values obtained from the statistical analysis to each coefficient extracted from the DCT transform applied to the original back-scattering signal, performed in the previous study with the same dataset (top) and from the phase portion of FFT coefficient from the same signals, conducted in the present work.

FIG. 6: Graphical representation of the results obtained regarding the statistical comparisons involving 4 classes (Kruskall-Wallis test) and 2-classes (Mann-Whitney test), performed in experiment 2. (A) Results obtained for the first set of parameters: phase-spectrum derived statistical features. (B) Results obtained for the second set of parameters: Phase portion of the first 40 FFT coefficients. p-values obtained for each individual coefficient in 4-class comparison (top) and 6 different binary combinations (below).

FIG. 7: Continuous-time signal and its advanced and delayed versions.

FIG. 8: (A) Phase changes observed with a time domain shift. (B) After phase calculation and unwrapping, a linear phase is obtained as expected for the symmetrical signals use, which confirms that the algorithm applied provides a correct phase representation.

FIG. 9: Pulse-like waveforms reconstructed to observe the informative content of phase. By replacing the magnitude for random values, the reconstructed signal is based solely on the information contained in the phase. The presence of the edges presented in the original signal reveals the potential of phase to capture patterns related with the location of events in the time domain.

### DETAILED DESCRIPTION

In order to study the potential of phase-derived information for microparticles categorization, two sets of experiments were conducted, using the back-scattering signals acquired in the scope of iLOF technique development. All the information regarding particle characterization and sample preparation protocols, signal acquisition, and processing was provided from such previous works, namely, for simple microparticles and considering cancer-derived cells. Firstly, phase-derived features were tested to differentiate three simple microspheres and cells trapped by the fiber tip-PMMA, Polystyrene and living yeast-in distilled water. In the second experiment, the set of features was applied to complex human cancer-derived cells as targets, suspended in Phosphate Buffered Saline (PBS). These are based on a human gastric carcinoma cell line, where two different cells were used: Mock and HST6 cancer cells [10]. The two cells present the same genetic composition and morphology, only differing in the surface glycosylation since HST6 cells are transfected with a vector over-expressing the ST6GalNAc1 glycosyltransferase, an enzyme leading to the biosynthesis of the well-established tumor derived carbohydrate with poor prognosis of cancer patients [30]. A third class with PS particles was added, functioning as a control target [10]. Synthetic particles and cells were optically manipulated during experiments under controlled temperature, atmosphere, and humidity, at 37° in an atmosphere of 5% CO₂. A detailed description of samples preparation protocols and glycan characterization of the cancer cells was already provided in the previous work [10].

For each experiment, a “No particle” class was created by acquiring the signal with the polymeric tip into an empty area, with no particle trapped, in order to evaluate the ability to detect the presence of micro-structures [29], [31]. The information about the different experiments and samples used is provided in Table I.

TABLE I
Description of the particles involved in each experiment,
corresponding optical and morphological properties

| | | Diameter | Refractive | Number | Liquid |
|---|---|---|---|---|---|
| Exp. | Particle | (μm) | index | particles | phase |
| 1 | Polystyrene | 8 | 1.580 | 18 | Distilled |
| | PMMA | 8 | 1.480 | 16 | water |
| | Yeast cells | 6-7 | 1.500 | 16 | |
| 2 | Mock cells | 15.6 ± 2.9 | 1.360 | 15 | Phosphate |
| | HST6 cells | 16.2 ± 3.1 | 1.360 | 15 | Buffered |
| | Polystyrene | 8.0 ± 1.6 | 1.570 | 10 | Saline |

The following pertains to Optical Trapping and Particles Sensing

The visualization, manipulation and acquisition of the back-scattering signal occurs through optical setup described in previous works [10], mainly composed by an inverted microscope, a motorized micromanipulator holding an optical fiber tip, and a signal acquisition module. A key element is the polymeric spherical lens fabricated on top of the optical fiber that ensures a stable trapping of particles. For each solution considered, the optical fiber with the lensed tip on its extremity is inserted into a sample drop containing the particles, placed over a glass coverslip over the inverted microscope setup. The laser is then turned on (@980 nm; optical fiber tip output power of 10±2 mW), with the immersed lensed tip carefully positioned in front of an isolated particle. Once the particles are stably trapped, the image acquisition system, connected to a laptop, allows its visualization and the back-scattering signal is acquired through the photodetector, at a sampling rate of 5 kHz.

The following pertains to Back-scattering Signal Processing and Analysis

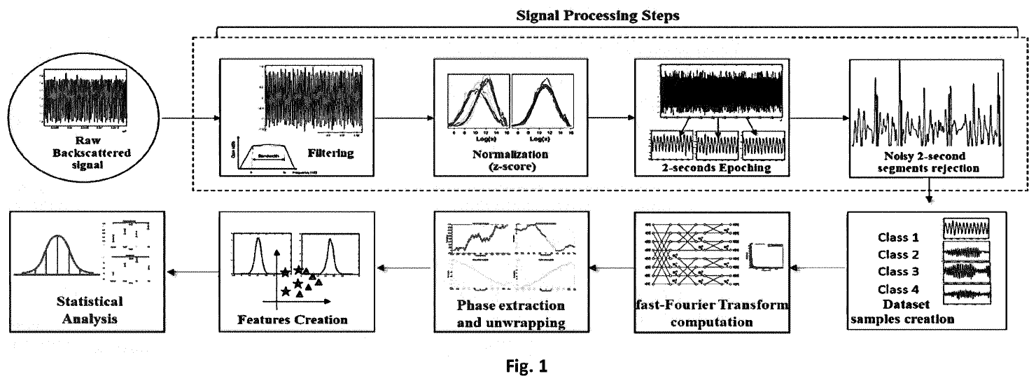

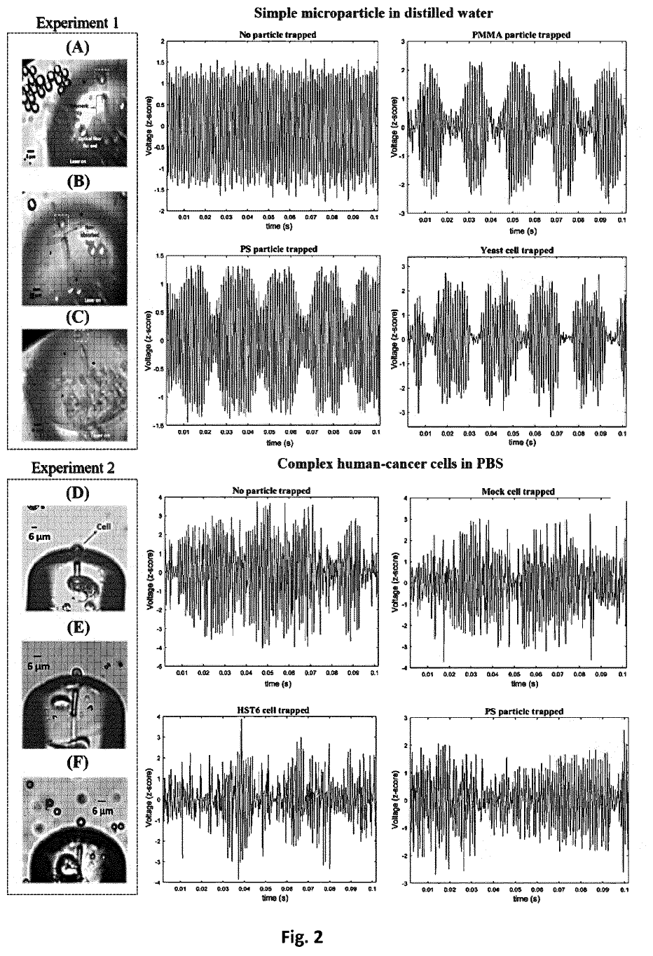

For all the experiments conducted, the same signal processing pipeline was applied to the back-scattering signals, represented in FIG. 1. After acquisition, each signal was analyzed and processed through through a MATLAB 2019b® custom-built script. Since the input radiation laser was modulated with a 1 kHz sinusoidal signal, low-frequency components, such as the 50 Hz electrical grid component, were removed through a second-order 500 Hz Butterworth high-pass filter. Then, artifacts were eliminated by computing the z-score, followed by the segmentation of each signal into signal portions of 2 seconds. A threshold of |z-score|=5 was defined to remove noisy signal epochs whose values did exceed the condition, in order to improve the Signal-to-Noise Ratio (SNR). Through these steps, 2-second normalized back-scattering signal portions were obtained for each particle dispersion, with a reasonable SNR for the particles type differentiation to be possible. Sketches of processed back-scattering signals for each class and media tested are presented in FIG. 2. The different classes for each experiment were then created. The following steps involve the computation of fast-Fourier Transform (FFT) to obtain the frequency-domain representation signals, in order to extract the phase spectrum that is processed through a phase unwrapping procedure. After continuous phase spectral representations were obtained for each class, the set of phase-derived features was extracted and each feature was individually evaluated in the statistical analysis stage, between the selected classes for each problem and all possible pairwise combinations.

The following pertains to Back-scattering Phase-Based Features

After signal processing, in order to extract the encoded phase information, the frequency-domain spectral representation of the signal was obtained through the widely known Discrete Fourier Transform (DFT) [33]. To implement DFT, the efficient Fast-Fourier Transform (FFT) algorithm was applied.

The Fourier phase angles are calculated from the inverse tangent function [19]:

$$φ ( ω ) = arctan [ ( Im ( X ( ω ) ) / ( Re ( X ( ω ) ) ] \qquad ( 1 )$$

Where Im and Re are the imaginary and real components of the complex Fourier spectrum of the data. Consequently, the Fourier phase function is forced to the principal value range [−π,π] [19]. When the difference between two consecutive phase angles exceeds such interval, values are wrapped around zero, creating a highly discontinuous signal known as wrapped phase [15], [26]. To apply feature extraction methods and obtain useful information, such discontinuities need to be removed from the principal values to a continuous phase map—a process called phase unwrapping [13], [15], [26].

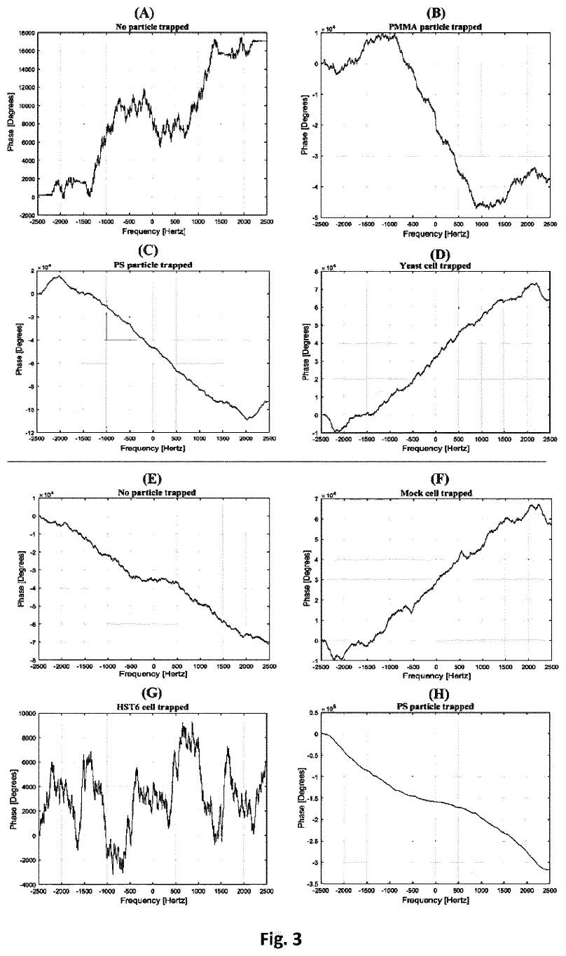

Despite the variety of methods that have been proposed over the years [34]-[38] these are not widely tested and several difficulties are reported by the authors. The most commonly used and accepted phase unwrapping algorithm is the numerical integration method developed by Tribolet [39], used in this study. This consists in the detection of phase wraps, followed by a compensation through a 2π addiction or subtraction to ensure the continuity of the spectrum [13], [40]. To apply such algorithm, the built-in MATLAB function unwrap was used. Considering the reduced amount of literature on phase unwrapping and the well-known challenges associated, the phase calculation and processing procedure was tested through a series of validation experiments involving synthetic signals with a linear phase [33], that confirmed the suitability of the algorithm applied to provide a correct phase representation and retain information of the location of events in the time domain signal. More details are provided on Appendix. Therefore, this method was used to extract the unwrapped phase spectrum of each class evaluated (FIG. 3).

After applying the phase extraction procedure and obtaining an unwrapped phase map distribution, phase related information was exploited through a set of frequency domain derived features, composed by two different subsets. The first subset, based on descriptive statistics, contains 8 measurements extracted from the phase spectrum (phase as a function of frequency), that include Standard Deviation (STD), Root Mean square (RMS), Interquartile (IQR), Range, Kurtosis, Skewness, Variance and Entropy. Such parameters were already applied in time-domain information in previous works of our lab and are reported to be efficient in differentiating periodic signals from different origins and sources (synthetic, biological) [41]-[45]. The second subset of features is based on FFT coefficients. It is found in the literature that the majority of feature extraction methods are heavily based on the magnitude of the FFT coefficients, despite being reported that the phase of the coefficients can also play a useful role in various applications [19], [46], [47]. Thus, in this work, the unwrapped phase of the first, e.g. 40, FFT coefficients was calculated and used as, e.g. 40, individual features. This number was already applied in previous works and is supported by different reports that present higher accuracy values for a similar number of coefficients. [10], [48 ], [49].

The following pertains to Statistical analysis

Normality and Homogeneity assumptions were first verified for all variables through Shapiro-Wilk and Levene test. Since the p-value obtained from both tests was below the significance threshold of 0.05, Non-Parametric tests were selected, since these present less stringent requirements [50]. Firstly, a comparison between all the conditions of each experiment was conducted (4-class comparison problem) using Kruskal-Wallis test. This was followed by a post-hoc analysis to compare groups in a pairwise manner (2-classes), that is designed to guard against the possibility of an increased Type 1 error (rejection of a true null hypothesis) due to the large number of different comparisons being made [50]. Such procedure was conducted using Mann-Whitney test, commonly used to test for differences between two independent groups on a continuous measure. For all the statistical tests performed, a significance level of p-value=0.05 was considered.

The discriminative ability of phase-based features was evaluated for particles of different sources (synthetic, biological), structural and molecular complexity (from simple microspheres to complex mammalian cells). Skewness presented p-value˜1 for all conditions evaluated, thus this parameter was discarded.

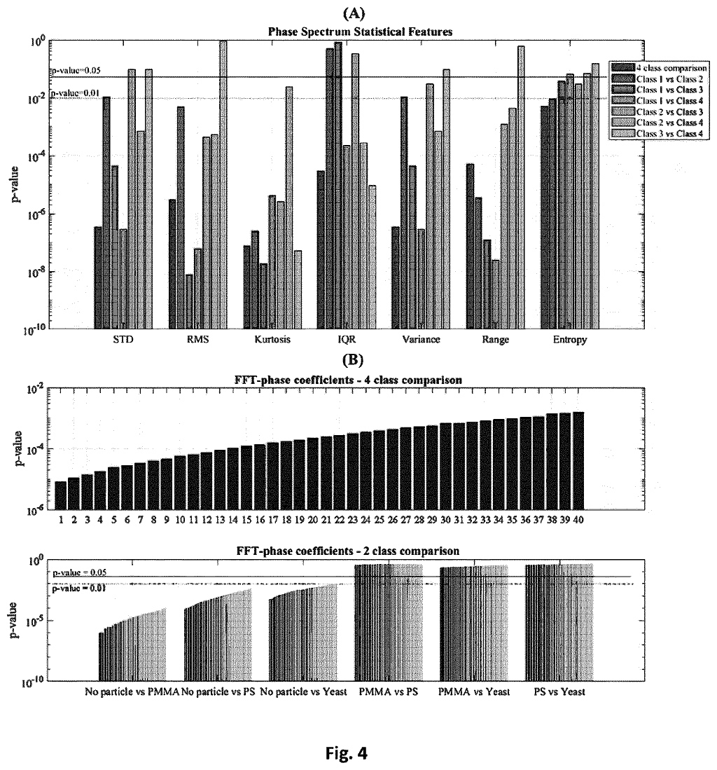

The following pertains to Experiment 1. The p-value results obtained for each test (Kruskal-Wallis, Mann-Whitney) are schematically presented in FIG. 4.

It is observed that, excluding Skewness, all statistical features and FFT-phase coefficients were revealed to be significantly different when comparing the 4-classes of particles, which indicates the potential of unwrapped phase-derived features for trapped micro-particles detection and discrimination techniques using OFT back-scattering signals. Besides, considering the binary combinations, the selected attributes were able to capture the presence of a trapped particle with great discriminative potential (p-value<0.01). In the comparisons between trapped synthetic particles (PMMA vs PS) and a synthetical versus biological particle (PMMA vs Yeast, PS vs Yeast) the discriminative potential of the phase-based features decreased (p-values above the significance threshold), which may be a consequence of the similar structural properties of the cells under analysis. Although the synthetic microspheres significantly differ from biological particles, yeast cells are one of the simplest eukaryotic organisms, only delimited structurally by a cell wall and constituted by a reduced number of organelles. Since the synthetic particles analyzed did not undergo processes of surface functionalization, these are also characterized by a very simple structure. Considering that the scattering patterns and phase shifts present in the signal are expected to be related to the number of cell layers and structural properties that define different particle types, the poor separability of classes may be a consequence of the simplicity and high similarity of morphological and structural characteristics. Nevertheless, the results obtained in the 4-class comparison reveal a considerable discriminative potential of the set of features, which is translated in very small p-value results.

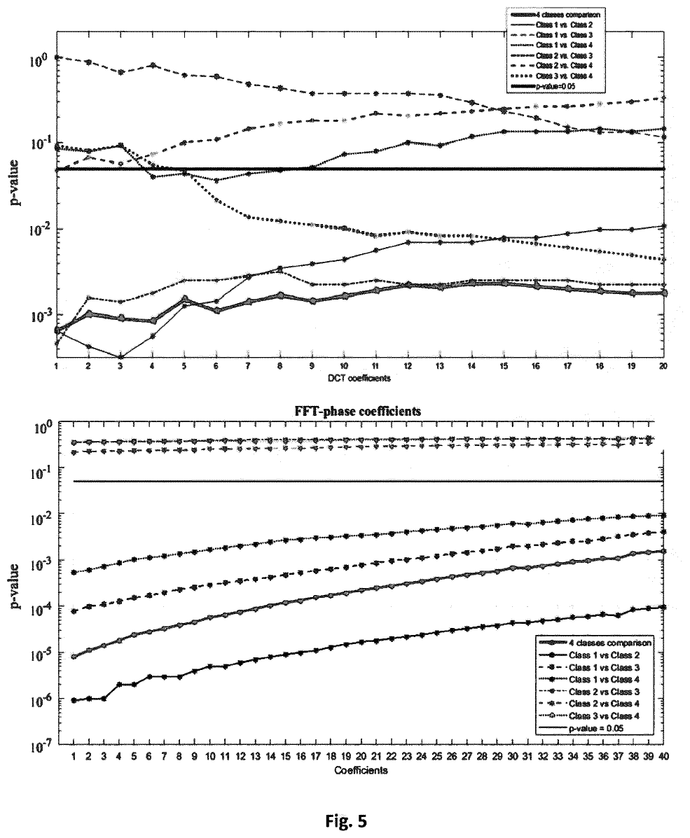

Since in the previous study conducted with the same dataset [29], equal statistical analysis methods were applied, it is possible to compare the results retrieved by the two different sets of parameters extracted from the back-scattering signal. In the previous approach, a total of 45 features was selected to characterize each class, based on time-domain (statistical and histogram-derived features) and frequency-domain (Discrete Cosine Transform (DCT)-derived features and Wavelet features). Comparing with the results obtained through the set of phase-based features, the statistical features calculated from the phase spectrum of the back-scattering signals presented better discrimination capability for the binary combinations, with one feature (Kurtosis) able to differentiate with statistical significance all binary classes. The comparison regarding the DCT and FFT coefficients is presented in FIG. 5. Considering the 4-class comparisons, a considerably lower p-value (higher discriminative potential) is obtained for all coefficients. Besides, a much better discrimination ability (p-values<10\hat{ }(-06)) for classes involving the “No particle” condition is presented in contrast with the results obtained for the DCT coefficients based on the magnitude of the signal, where such condition is associated with poor statistical significance (higher p-value). This is an important result since it reveals that the phase of FFT coefficients is able to retain important information of the particle and provide good discrimination performance in short duration signal portions (2 seconds), compared with the magnitude of the DCT coefficients, that is usually explored in detriment of phase. Besides, DCT is a technique well-known for its compression capabilities and ability to capture minimal periodicities of a signal. [29], [51 ]

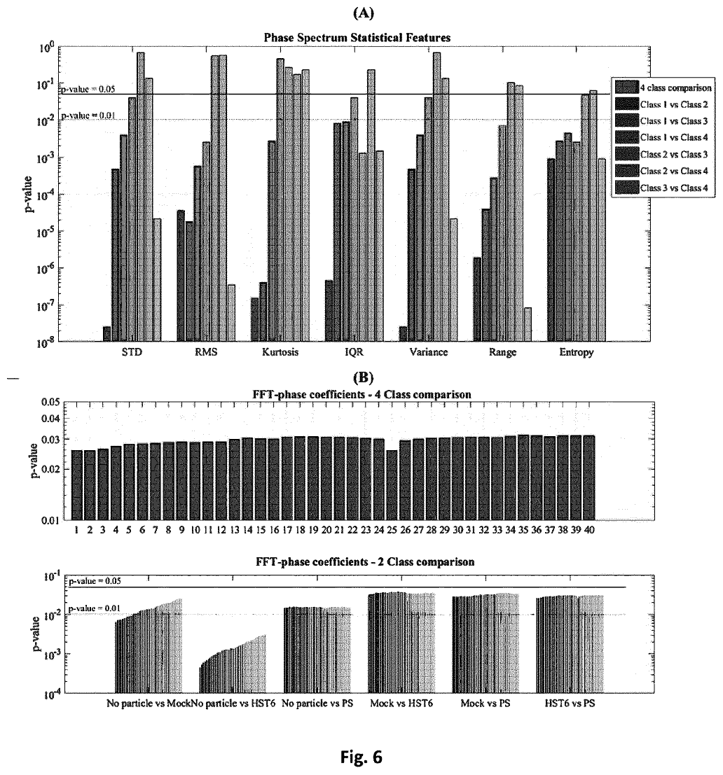

The following pertains to Experiment 2. The p-value results obtained for each test (Kruskal-Wallis, Mann-Whitney) are schematically presented in FIG. 6.

As observed in FIG. 6, the most promising results are found for the second feature subset, where all FFT-phase coefficients present significant differences for the 4-class comparison and all the 6 binary combinations considered (p-value<0.05). These showed to be suitable not only to identify the presence of a trapped particle but also to discriminate between biological (tumoral cells) vs synthetic (PS) particles and even between the two very similar biological cells (Mock and HST6). Comparing with the results of Experiment 1, with simple microparticles, these results show that the phase portion of FFT coefficients presents a higher discrimination power for complex biological particles. Since mammalian cells contain a wide variety of cellular structures (microtubules, microfilaments) and organelles with a complex, hydrodynamic outermost layer with phospholipids and proteins embedded, there is a significantly higher heterogeneity and complexity degree present, in comparison with simple synthetic structures. The differential surface glycosylation patterns on the cancer-derived cells probably originated different interactions of light with the glycans coat around each cell. Besides, the modified cell line can also present a different internal layer constitution, that can behave as resonant cavities when the light interacts with the cell. Thus, we postulate that all of these factors can intensify the light-matter interactions during the light optical path, translated by distinct phase shifts in the back-scattering signal, that can be explored as biological signatures of the particles under analysis. This is an important outcome considering the current challenges of cancer and other disease detection methodologies based on single-cell fast screening. Since these are slight cellular changes, only affinity and biochemical assays, involving fluorescence, or highly sensitive spectral and imaging techniques are able to detect them, which prompts a crescent demand for simple and efficient techniques able to identify cancer cell alterations with high inter-cell similarity. In this context, the sensitivity of the 40 individual features to cancer-associated glycoforms expressed at the surface presents a great potential for single-cell characterization methods such as cancer biomarker assays. Besides, considering that alterations in the glycosylation process are linked to tumor development, these can also be applied in personalized therapeutic approaches and early disease assessment methodologies.

The potential of phase spectral information is thus shown for detection and discrimination of micro (bio)particles present in different liquid suspensions used in biological assays. The results reveal that phase is a potential new contributor to obtain discriminative light patterns strongly related to the structural properties of each cell, that are enhanced with an increase in particle complexity and heterogeneity degree. The presented subset of features was capable to successfully discriminate two highly similar human cancer cells, only differing in the surface glycosylation patterns. This is an extraordinary outcome in view of the current challenges of cancer and other diseases detection methodologies based on single-cell fast screening and, specifically, using optical fiber for signal detection. In comparison with a set of time and magnitude-based features, previously used in iLOF studies, better discrimination results were obtained regarding the statistical analysis conducted, which enhances the informative content of phase and potential for biological particle differentiation problems, important for applications in point-of-care diagnosis such as identification of cells or other sub-cell bio-particles with important clinical outcomes, circulating in the blood or its derivatives. Since phase information can be represented and analyzed using different methods such Hilbert or Hartley transforms, also used for phase spectral processing [52], [53], we intend to compare, in a future work, the discriminative properties of phase-based features extracted from such techniques in order to evaluate the most effective method to apply on feature extraction methodologies based on phase spectral information. Besides, considering the growing importance of nanotechnologies, this includes the application of the proposed set of phase-based features for detection and discrimination of nano-sized particles, suspended in biofluids, in order to assess the discriminative potential of phase for a smaller target dimension, with no individual trapping-an analysis with great relevance for in-vivo biosensing and biomarker-identification strategies.

The phase unwrapping procedure was tested through validation experiments involving synthetic signals with a linear phase (based on [33]). When a signal is symmetric with respect to the origin, it is expected to be zero phase. By shifting the signal in time, a change in the slope of the linear phase must be observed. The left-right symmetry was generated through the sinc function [54]:

$$sinc ( t ) = \frac{sin π t}{π t} \qquad ( 2 )$$

Using this function, three signals were created. To the original signal x(t):

$$x ( t ) = A sinc ( 2 π f t ) \qquad ( 3 )$$

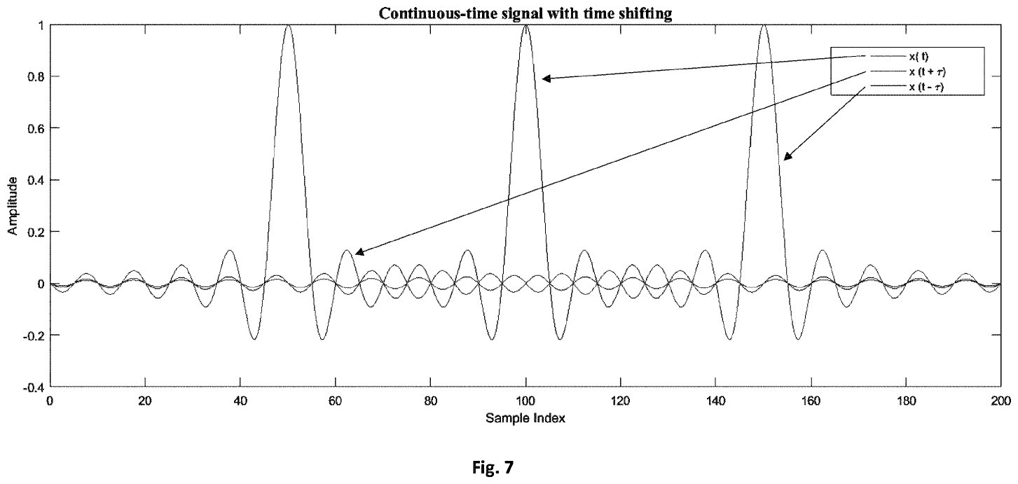

a time delay and advance were introduced, respectively, by [54]:

$$\begin{matrix}{x}_{2} ( t ) = A sinc ( 2 π f ( t - τ ) ) \\ {x}_{3} ( t ) = A sinc ( 2 π f ( t + τ ) )\end{matrix} \qquad ( 4 )$$

Where τ represents the time shift in seconds. This results in the original signal x(t) shifted to the right in x₂(t) and to the left in x₃(t) [33], (FIG. 7) for τ=0.5 s.

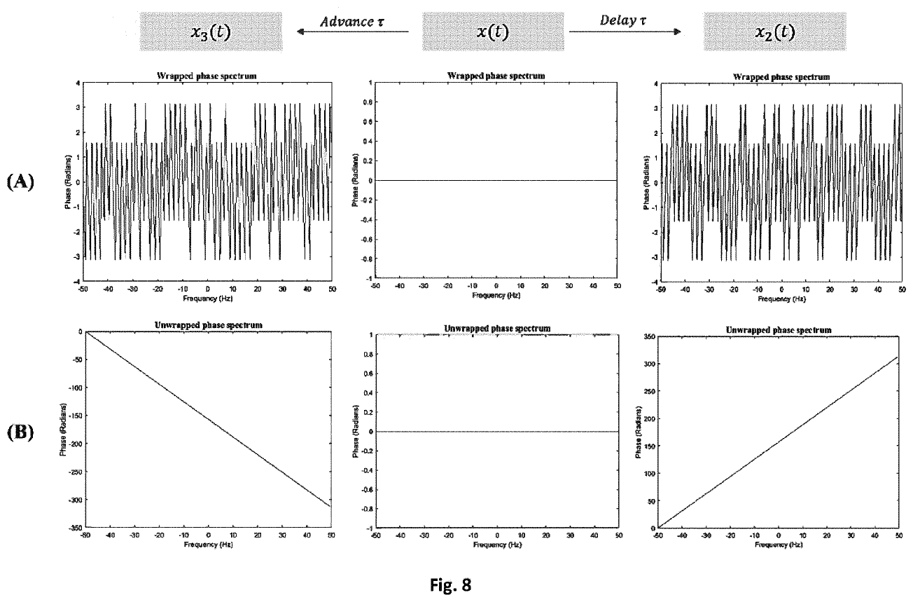

The spectral representations obtained after applying FFT, small magnitude values removal, phase calculation and unwrapping are presented on FIG. 8. After phase calculation, the π discontinuities present were compensated through the phase unwrapping algorithm. As it was expected, a linear phase response is obtained from the symmetrical time domain waveform. When the peak is centered on sample N/2, it presents zero phase [33]. By shifting in the time domain, a changing in the slope of the linear phase is observed. It confirms that the algorithm applied provides a correct phase representation and can be used to extract phase spectrum from the back-scattering signals.

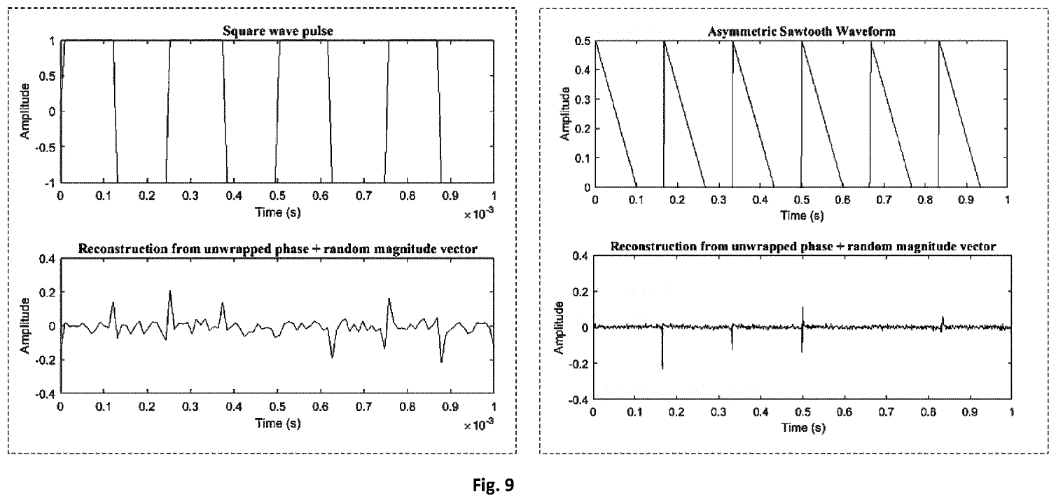

A last test was conducted to observe the information content of phase in a 1D signal, also based on [33]. DFT was applied to two different pulse-like waveforms and signal was reconstructed by calculating the phase, replacing the magnitude with random numbers, and taking the Inverse DFT. The results are presented in FIG. 9. It is observed that the location of the edges is retained, which reveals that information of the location of events in the time domain signal is contained in phase. Therefore, it is suitable to the present problem where it is intended to analyze patterns of back-scattering signal through phase spectrum.

The term “comprising” whenever used in this document is intended to indicate the presence of stated features, integers, steps, components, but not to preclude the presence or addition of one or more other features, integers, steps, components or groups thereof.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the disclosure as described herein may be incorporated as code (e.g., a software algorithm or program) residing in firmware and/or on computer useable medium having control logic for enabling execution on a computer system having a computer processor, such as any of the servers described herein. Such a computer system typically includes memory storage configured to provide output from execution of the code which configures a processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The disclosure should not be seen in any way restricted to the embodiments described and a person with ordinary skill in the art will foresee many possibilities to modifications thereof. The above described embodiments are combinable. The following claims further set out particular embodiments of the disclosure.

### REFERENCES

[1] G. Keiser, Biophotonics: Concepts to Applications, 1st ed. 2016.
[2] A. Tokmakoff, “Interaction of Light and Matter,” Time Dependent Quantum Mechanics and Spectroscopy, 2020. [Online]. Available: https://chem.libretexts.org/@go/page/107257. [Accessed: 06-Jun-2021].
[3] Z. Mei et al., “Applying an optical space-time coding method to enhance light scattering signals in microfluidic devices,” Biomicrofluidics, vol. 5, no. 3, 2011, doi: 10.1063/1.3624740.
[4] T.-F. Wu, S. H. Cho, Y.-J. Chiu, and Y.-H. Lo, “Lab-on-a-Chip Device and System for Point-of-Care Applications,” in Handbook of Photonics for Biomedical Engineering, Springer Netherlands, 2013, pp. 1-30.
[5] M. Consales, M. Pisco, and A. Cusano, “Lab-on-fiber technology: A new avenue for optical nanosensors,” Photonic Sensors, vol. 2, no. 4. Springer, pp. 289-314, 13-Dec-2012, doi: 10.1007/s13320-012-0095-y.
[6] B. Kuswandi, Nuriman, J. Huskens, and W. Verboom, “Optical sensing systems for microfluidic devices: A review,” Anal. Chim. Acta, vol. 601, no. 2, pp. 141-155, 2007, doi: 10.1016/j.aca.2007.08.046.
[7] P. Vaiano et al., “Lab on Fiber Technology for biological sensing applications,” Laser Photon. Rev., vol. 10, no. 6, pp. 922-961, November 2016, doi: 10.1002/lpor.201600111.
[8] A. Ricciardi et al., “Lab-on-fiber technology: A new vision for chemical and biological sensing,” Analyst, vol. 140, no. 24, pp. 8068-8079, 2015, doi: 10.1039/c5an01241d.
[9] J. S. Paiva, P. A. S. Jorge, C. C. Rosa, and J. P. S. Cunha, “Optical fiber tips for biological applications: From light confinement, biosensing to bioparticles manipulation,” Biochim. Biophys. Acta-Gen. Subj., vol. 1862, no. 5, pp. 1209-1246, 2018, doi: 10.1016/j.bbagen.2018.02.008.
[10] J. S. Paiva et al., “iLOF: An intelligent Lab on Fiber Approach for Human Cancer Single-Cell Type Identification,” Sci. Rep., vol. 10, no. 1, p. 3171, 2020, doi: 10.1038/s41598-020-59661-5.
[11] J. Paiva, “Intelligent Lab on Fiber tools for sensing single-cells and extracellular nano-vesicles,” University of Porto, 2019.
[12] E. Loweimi, S. M. Ahadi, and H. Sheikhzadeh, “Phase-only speech reconstruction using very short frames,” in Proceedings of the Annual Conference of the International Speech Communication Association, INTERSPEECH, 2011, no. January, pp. 2501-2504.
[13] I. Paraskevas and E. Chilton, “Combination of magnitude and phase statistical features for audio classification,” Acoust. Res. Lett. Online, vol. 5, no. 2004, pp. 111-117, 2004, doi: 10.1121/1.1755731.
[14] J. Deng, X. Xu, Z. Zhang, S. Fruhholz, and B. Schuller, “Exploitation of Phase-Based Features for Whispered Speech Emotion Recognition,” IEEE Access, vol. 4, no. December, pp. 4299-4309, 2016, doi: 10.1109/ACCESS.2016.2591442.
[15] L. D. Alsteris and K. K. Paliwal, “Short-time phase spectrum in speech processing: A review and some experimental results,” Digit. Signal Process. A Rev. J., vol. 17, no. 3, pp. 578-616, 2007, doi: 10.1016/j.dsp.2006.06.007.
[16] B. Y. H. A. Murthy, K. V. M. Murthy, “Formant extraction from phase using weighted group delay function,” Electron. Lett. 25, vol. 25, no. 23, pp. 1609-1611, 1989, doi: 10.1049/el: 19891080.
[17] B. Yegnanarayana and H. A. Murthy, “Significance of Group Delay Functions in Spectrum Estimation,” IEEE Trans. Signal Process., vol. 40, no. 9, pp. 2281-2289, 1992, doi: 10.1109/78.157227.
[18] K. K. Paliwal and L. Alsteris, “Usefulness of phase spectrum in human speech perception,” Microelectron. Eng.—INTERSPEECH 2003, pp. 2117-2120, 2003.
[19] A .V. Oppenheim and J. S. Lim, “The Importance of Phase in Signals,” Proc. IEEE, vol. 69, no. 5, pp. 529-541, 1981, doi: 10.1109/PROC.1981.12022.
[20] E. Loweimi, S. M. Ahad, and T. Drugman, “A new phase-based feature representation for robust speech recognition.,” in IEEE International Conference on Acoustics, Speech and Signal Processing, 2013, pp. 7155-7159.
[21] B. Bozkurt and L. Couvreur, “On the use of phase information for speech recognition,” 13th Eur. Signal Process. Conf. EUSIPCO 2005, pp. 999-1002, 2005.
[22] R. M. Hegde, H. A. Murthy, and V. R. R. Gadde, “Significance of joint features derived from the modified group delay function in speech processing,” Eurasip J. Audio, Speech, Music Process., vol. 2007, no. January 2006, 2007, doi: 10.1155/2007/79032.
[23] K. Paliwal, K. Wójcicki, and B. Shannon, “The importance of phase in speech enhancement,” Speech Commun., vol. 53, no. 4, pp. 465-494, 2011, doi: 10.1016/j.specom.2010.12.003.
[24] M. Koutsogiannaki, O. Simantiraki, G. Degottex, and Y. Stylianou, “The importance of phase on voice quality assessment,” Proc. Annu. Conf. Int. Speech Commun. Assoc. INTERSPEECH, no. September, pp. 1653-1657, 2014.
[25] T. Drugman, T. Dubuisson, and T. Dutoit, “Phase-based information for voice pathology detection,” ICASSP, IEEE Int. Conf. Acoust. Speech Signal Process.—Proc., no. June 2014, pp. 4612-4615, 2011, doi: 10.1109/ICASSP.2011.5947382.
[26] I. Paraskevas, “Phase as a Feature Extraction Tool for Audio Classification and Signal Localisation,” University of Surrey (United Kingdom), 2004.
[27] A. V. Oppenheim, J. S. Lim, G. Kopec, and S. C. Pohlig, “Phase in Speech and Pictures.,” no. April, pp. 632-637, 1979, doi: 10.1109/icassp.1979.1170798.
[28] L. Liu, J. He, and G. Palm, “Effects of phase on the perception of intervocalic stop consonants,” Speech Commun., vol. 22, no. 4, pp. 403-417, 1997, doi: 10.1016/S0167-6393 (97) 00054-X
[29] J. S. Paiva, R. S. R. Ribeiro, J. P. S. Cunha, C. C. Rosa, and P. A. S. Jorge, “Single particle differentiation through 2d optical fiber trapping and back-scattered signal statistical analysis: An exploratory approach,” Sensors (Switzerland), vol. 18, no. 3, pp. 1-30, 2018, doi: 10.3390/s18030710.
[30] N.T. Marcos et al., “Role of the human ST6GalNAc-I and ST6GalNAc-II in the synthesis of the cancer-associated Sialyl-Tn antigen,” Cancer Res., vol. 64, no. 19, pp. 7050-7057, 2004, doi: 10.1158/0008-5472.CAN-04-1921.
[31] J. S. Paiva, P. A. S. Jorge, R. S. R. Ribeiro, P. Sampaio, C. C. Rosa, and J. P. S. Cunha, “Optical fiber-based sensing method for nanoparticle detection through supervised back-scattering analysis: A potential contributor for biomedicine,” Int. J. Nanomedicine, vol. 14, pp. 2349-2369, 2019, doi: 10.2147/IJN.S174358.

The above references are hereby incorporated in their entirety.

1. A method for detecting and/or classifying particles of organic based compounds from a backscattered light fingerprint, in a liquid dispersion sample, said method using an electronic data processor configured by code to detect and/or classify particles of organic based compounds in the liquid dispersion sample using a machine learning classifier, the method comprising the use of the electronic data processor for pre-training the machine learning classifier with a plurality of specimen particles by:
emitting a laser modulated by a modulation frequency onto each specimen;
acquiring a temporal signal from laser light backscattered by each specimen for a plurality of temporal periods of a predetermined duration for each specimen;
calculating specimen phase-domain coefficients from the acquired specimen signal for each of the temporal periods by applying a phase-domain transform; and
using the calculated specimen coefficients to pre-train the machine learning classifier for detecting and/or classifying the particles.

2. The method according to claim 1, wherein the electronic data processor is further configured by code:
using a laser emitter to emit the laser modulated by the modulation frequency onto the liquid dispersion sample;
using a light receiver to acquire a signal from laser light backscattered by the liquid dispersion sample for a plurality of temporal periods of a predetermined duration;
calculating sample phase-domain coefficients from the acquired sample signal for each of the temporal periods by applying the same phase-domain transform as used for the specimen; and
using the pre-trained machine learning classifier to detect and/or classify from the calculated sample coefficients the particles.

3. The method according to claim 1, wherein the phase-domain transform used for obtaining phase-domain coefficients is the Fourier transform, the Hilbert transform or the Hartley transform.

4. (canceled)

5. (canceled)

6. The method according to claim 1, wherein the phase-domain coefficients comprise the Standard Deviation, Root Mean square, Interquartile, Range, Kurtosis, Skewness, Variance, Entropy, or combinations thereof, extracted from a phase spectrum obtained from the applied phase-domain transform.

7. The method according to claim 1, wherein the calculating of phase-domain coefficients from the acquired signal comprises phase unwrapping the applied phase-domain transform.

8. The method according to claim 1, wherein the particles are micron sized, in particular below 1 μm.

9. The method according to claim 1, wherein the machine learning classifier is a Linear Discriminant Analysis (“LDA”) machine learning classifier.

10. The method according to claim 1, comprising the use of Optical Tweezers, in particular Optical Fiber Tweezers (“OFT”) for emitting the laser onto the particles and for acquiring the signal from backscattered light.

11. The method according to claim 1, wherein the laser is a visible light laser or an infrared laser and wherein the laser is further modulated by one or more additional modulation frequencies.

12. (canceled)

13. The method according to claim 1, wherein the captured plurality of temporal periods of a predetermined duration are obtained by splitting a captured temporal signal of a longer duration than the predetermined duration, and wherein the split temporal periods are overlapping temporal periods.

14. (canceled)

15. (canceled)

16. The method according to claim 1, further comprising a focusing optical system coupled to the emitter, wherein the focusing optical system is a convergent lens.

17. (canceled)

18. (canceled)

19. (canceled)

20. (canceled)

21. (canceled)

22. (canceled)

23. (canceled)

24. (canceled)

25. A non-transitory storage medium including program instructions for implementing a method for detecting and/or classifying particles of organic based compounds from a backscattered light fingerprint, in a liquid dispersion sample, the program instructions including instructions executable by an electronic data processor to carry out the method of claim 1.

26. (canceled)

27. A device for detecting and/or classifying particles of organic based compounds from a backscattered light fingerprint, in a liquid dispersion sample, said device comprising a laser emitter and a light sensor, and an electronic data processor configured by code to detect and/or classify particles of organic based compounds in the liquid dispersion sample using a machine learning classifier, arranged for pre-training the machine learning classifier with a plurality of specimen particles of organic based compounds, by:
emitting a laser modulated by a modulation frequency onto each specimen;
acquiring a temporal signal from laser light backscattered by each specimen for a plurality of temporal periods of a predetermined duration for each specimen;
calculating specimen phase-domain coefficients from the acquired specimen signal for each of the temporal periods by applying a phase-domain transform; and
using the calculated specimen coefficients to pre-train the machine learning classifier for detecting and/or classifying the particles.

28. The device according to claim 27, further comprising the pretrained machine learning classifier.

29. The device according to claim 27, wherein the electronic data processor is arranged for detecting and/or classifying the particles of organic based compounds by:
using a laser emitter to emit a laser modulated by a modulation frequency onto the sample;
using a light receiver to acquire a signal from laser light backscattered by the sample for a plurality of temporal periods of a predetermined duration;
calculating sample phase-domain coefficients from the acquired sample signal for each of the temporal periods by applying the same phase-domain transform as used for the specimen; and
using the pre-trained machine learning classifier to detect and/or classify from the calculated sample coefficients the particles.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The device according to claim 27, further comprising a focusing optical system coupled to the emitter, wherein the focusing optical system comprises a convergent lens.

44. (canceled)

45. The device according to claim 43, wherein the focusing optical system is a focusing optical system arranged to provide a field gradient pattern.

46. (canceled)

47. The device according to claim 43, wherein the lens has a base diameter of 5-10 μm.

48. The device according to claim 43, wherein the lens has a curvature radius of 2-5 μm.

49. The device according to claim 27, wherein the light receiver is an infrared photoreceptor comprising a bandwidth of 400-1000 nm.

50. (canceled)

51. (canceled)

52. (canceled)
